(19) United States
(12) Patent Application Publication
(10) Pub. No.: US 2009/0307270 A1
(43) Pub. Date: Dec. 10, 2009

(54) System and method for providing device-specific data application

(75) Inventors: Wonjang Baek, Seongnam-si (KR); John Kim, Seoul (KR); Seong Baek Lee, Seoul (KR)

Correspondence Address: THE NATH LAW GROUP, 112 South West Street, Alexandria, VA, 22314, US

(73) Assignee: DREAMER, Burbank, CA (US)

(21) Appl. No.: 12/457,186

(22) Filed: Jun. 3, 2009

(30) Foreign Application Priority Data
Jun. 9, 2008 (KR) 10-2008-0053609

(51) Int. Cl. G06F 17/30; G06F 7/00

(52) U.S. Cl. 707/104.1; 707/E17.009; 707/200; 707/10; 707/E17.032; 707/E17.044

(57) ABSTRACT

A system and a method for providing a device-specific data application are disclosed. In accordance with the system and the method of the present invention, a digital media playback apparatus is provide with one of one or more data applications optimized for the digital media playback apparatus stored in a storage device to prevent a failure in executing the data application due to a system specifications and manufacturer thereof.

### BACKGROUND OF THE INVENTION

1. Field of the Invention

The present invention relates to a system and a method for providing a device-specific data application, and more particularly to a system and a method for providing a device-specific data application based on a system information of a digital media playback apparatus.

2. Description of the Related Art

A broadcasting environment is changing according to a progress in technologies and demands of viewers. A conventional analog broadcasting is under a transition to a digital broadcasting, and a broadcasting media is diversified from a terrestrial broadcasting into a cable broadcasting, satellite broadcasting, an IP-TV service via a ultrahigh speed communication network, a terrestrial DMB and a satellite DMB.

Under a digital broadcasting environment, various data applications may be transmitted along with a program signal enabling an interactivity by associating with the communication network.

Various data services using the various data applications are expected to play a major role in spreading the digital broadcasting due to a simple and easy use.

Recently, a next generation optical disk media capable of storing a large capacity video is under development as a Hi-Definition (HD) broadcasting is gaining popularity.

HD-DVD, Blu-ray disk have been proposed as the next generation optical disk media.

HDi (High Definition interactive) specification and BD-J specification are being developed in order to provide a data application service in a disk media playback apparatus. The HDi specification is a standard specification for the data application service and an advanced user menu function supported by HD-DVD. BD-J specification is a standard specification for the data application service supported by Blu-ray disk. The data application may be embodied and provided by using the standard specification for the optical disk storage media.

Hereinafter, a digital media playback apparatus refers to an apparatus, which is capable of receiving and providing the data application, for receiving the digital broadcasting to provide a broadcast program or reproducing a multimedia content stored in the next generation optical disk media.

For instance, the digital media playback apparatus may be a digital TV or a set-top box compliant to a terrestrial broadcasting standard such as ATSC and supporting an interactive data broadcasting standard such as DASE. The digital media playback apparatus may also be a digital TV or a set-top box supporting a data broadcasting standard such as OpenCable and DVB, OCAP and MHP. The digital media playback apparatus may also be a set-top box or a mobile communication terminal supporting a data broadcasting standard of IP-TV and DMB. The digital media playback apparatus may be a Blu-ray disk player capable of playing the Blu-ray disk and supporting the BD-J specification.

The data application may be embodied on a Java platform, and the digital media playback apparatus may support Java or Java-TV API.

A conventional method for providing the data application using the digital media playback apparatus has following drawbacks.

A creator of the data application creates the data application based on a suggested system specification instead of a device-specific system specification optimized for the digital media playback apparatus.

Therefore, the digital media playback apparatus having a system specification inferior to the suggested system specification cannot execute the data application.

Moreover, while the digital media playback apparatus having a system specification superior to the suggested system specification can execute the data application, the data application cannot be provided efficiently.

For instance, if the data application is in standard definition (SD), the digital media playback apparatus supporting the data application in high definition (HD) must provide the data application is in SD.

In addition, even when the digital media playback apparatus supports standards of the various data applications, some of the data applications cannot be executed.

For instance, there may a data application that can be executed in one digital media playback apparatus but cannot be executed in another digital media playback apparatus.

### SUMMARY OF THE INVENTION

It is an object of the present invention to provide a system and a method for providing a device-specific data application based on a system information of a digital media playback apparatus.

In order to achieve above-described object of the present invention, there is provided a data application providing system, comprising: a storage device for storing a data application group including one or more data applications; and a digital media playback apparatus for generating a data application selection information for selecting a device-specific data application from the one or more data applications, transmitting the data application selection information to the storage device, and receiving and providing the device-specific data application from the storage device.

Preferably, the data application selection information includes a system information of the digital media playback apparatus and an selection information of the data application group, and wherein the storage device selects the device-specific data application based on the data application selection information and transmits the device-specific data application to the digital media playback apparatus.

Preferably, the storage device selects the device-specific data application by comparing a specification information of each of the one or more data applications to the system information.

Preferably, the digital media playback apparatus receives the selection information of the data application group via a broadcast network or a communication network.

Preferably, the digital media playback apparatus reads the selection information of the data application group from a storage media.

Preferably, the data application selection information includes an selection information of the device-specific data application, and wherein the digital media playback apparatus generates the selection information of the device-specific data application based on a system information of the digital media playback apparatus and the selection information of the data application group.

Preferably, the selection information of the data application group includes a specification information of each of the one or more data applications, and wherein the digital media playback apparatus generates the selection information of the device-specific data application by comparing the specification information to the system information.

Preferably, the digital media playback apparatus receives the selection information of the data application group via a broadcast network or a communication network.

Preferably, the digital media playback apparatus reads the selection information of the data application group from a storage media.

There is also provided a data application providing method, comprising steps of: (a) generating a data application selection information for selecting a device-specific data application from one or more data applications included in a data application group stored in a storage device; (b) transmitting the data application selection information to the storage device; and (c) receiving and providing the device-specific data application from the storage device.

Preferably, the step (a) comprises: (a-1) receiving the selection information of the data application group; and (a-2) generating the data application selection information based on the selection information of the data application group.

Preferably, the step (a-1) comprises receiving the selection information of the data application group via a broadcast network or a communication network.

Preferably, the step (a-1) comprises reading the selection information of the data application group from a storage media.

Preferably, the step (a-2) comprises generating the data application selection information including a system information of the digital media playback apparatus and the selection information of the data application group.

Preferably, the data application selection information includes an selection information of the device-specific data application, and wherein the step (a-2) comprises (a-3) generating the selection information of the device-specific data application based on a system information of the digital media playback apparatus and the selection information of the data application group.

Preferably, the selection information of the data application comprises a specification information of each of the one or more data applications, and wherein the step (a-3) comprises generating the selection information of the device-specific data application by comparing the specification information to the system information.

### BRIEF DESCRIPTION OF THE DRAWINGS

FIG. 1 is a block diagram exemplifying a system for providing a device-specific data application in accordance with the present invention.

FIG. 2 is a flow diagram exemplifying a method for providing a device-specific data application in accordance with the present invention.

FIG. 3 is a flow diagram illustrating a first method for selecting a device-specific data application in accordance with the present invention.

FIG. 4 is a flow diagram illustrating a second method for selecting a device-specific data application in accordance with the present invention.

### DETAILED DESCRIPTION OF THE INVENTION

A system and a method for providing a device-specific data application in accordance with the present invention will be described with reference to accompanied drawings.

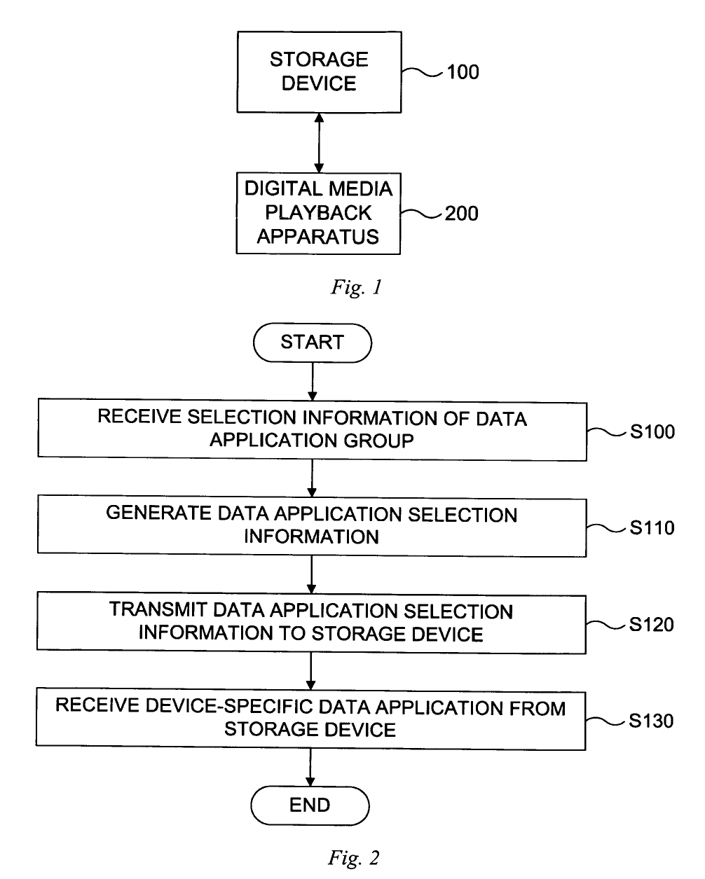

FIG. 1 is a block diagram exemplifying a system for providing a device-specific data application in accordance with the present invention.

Referring to FIG. 1, the system in accordance with the present invention comprises a storage device 100 and a digital media playback apparatus 200.

The storage device 100 stores a data application group including one or more data applications.

In accordance with one embodiment, the storage device 100 is connected to the digital media playback apparatus 200 via wired/wireless network such as the Internet. The storage device 100 may include a server for transmitting at least a portion of the one or more the data applications to the digital media playback apparatus 200.

In accordance with another embodiment, the storage device 100 may include a harddisk storage device, a large capacity non-volatile memory or a blu-ray disk connected to the digital media playback apparatus 200.

The data application group includes the one or more data application carrying out identical or similar functions. Each of the one or more data application is generated according to a system specifications or manufacturers.

For instance, a first data application group may include a first data application through a fourth data application. The first data application may be the data application optimized for a digital media playback apparatus manufactured by a first manufacturer, the second data application may be the data application optimized for a digital media playback apparatus manufactured by a second manufacturer, the third data application may be the data application optimized for a communication speed of 2 Mbps, and the fourth data application may be the data application optimized for the communication speed of 10 Mbps.

In addition, the one or more data application included in the data application group may be classified according to a system resource such as a performance of a signal processor and a capacity of a memory thereof and a standard specification for executing the data application.

The digital media playback apparatus 200 generates a data application selection information for selecting a device-specific data application for the digital media playback apparatus 200 from the one or more data applications.

The digital media playback apparatus 200 transmits the generated data application selection information to the storage device 100, and receives and provides the device-specific data application from the storage device 100.

The data application selection information contains the information for selecting the device-specific data application, i.e. The data application optimized for the digital media playback apparatus 200.

The device-specific data application may be selected by two following methods.

In accordance with a first method, generates the data application selection information including a system information thereof and an selection information of the data application group, and transmits the data application selection information to the storage device 100. The storage device 100 then selects the device-specific data application optimized for the digital media playback apparatus 200 and transmits the selected device-specific data application to the digital media playback apparatus 200.

The system information of the digital media playback apparatus 200 may include informations such as a manufacturer, a unique identification number, the performance of the signal processor, the capacity of the memory and a communication environment of the digital media playback apparatus 200.

The selection information of the data application group is used to identify the one or more data application group stored in the storage device 100.

The digital media playback apparatus 200 may receive the selection information of the data application group via a broadcast network or a communication network.

For instance, the digital media playback apparatus 200 may receive the selection information of the data application group for receiving and executing the data application included in the first data application group via the broadcast network while receiving and providing a digital broadcast. When the first data application group including the first data application through the fourth the data application and a second data application group including a fifth data application through a eighth the data application are stored in the storage device 100, the digital media playback apparatus 200 may transmit the data application selection information including the selection information of the first data application group to the storage device 100.

The storage device 100 then selects the first data application group according to the selection information of the first data application group included in the data application selection information.

Thereafter, the storage device 100 selects the device-specific data application optimized for the digital media playback apparatus 200 from the first data application through the fourth the data application included in the first data application group.

Specifically, the storage device 100 compares a specification information of each of the first data application through the fourth the data application to the system information of the digital media playback apparatus 200 included in the data application selection information to select the device-specific data application optimized for the digital media playback apparatus 200.

For instance, when the first data application is the data application optimized for the digital media playback apparatus manufactured by the first manufacturer, the second data application is the data application optimized for the digital media playback apparatus manufactured by the second manufacturer, the third data application is the data application optimized for the communication speed of 2 Mbps, and the fourth data application is the data application optimized for the communication speed of 10 Mbps according to an analysis of the specification information, and the digital media playback apparatus 200 is manufactured by the first manufacturer according to an analysis of the system information, the storage device 100 selects the first data application.

The selected data application is transmitted to the digital media playback apparatus 200 by the storage device 100.

Thereafter, the digital media playback apparatus 200 receives the data application transmitted from the storage device 100 and executes the received data application.

In accordance with another embodiment, the digital media playback apparatus 200 may read the selection information of the data application group from a storage media instead of receiving the selection information of the data application group via the broadcast network or the communication network

For instance, the digital media playback apparatus 200 may read the data application selection information, from the storage media, for receiving and executing the data application included in the first data application group during an execution of a digital multimedia content stored in the storage media such as a harddisk, a blu-ray disk and a DVD. Subsequent process is similar to that of receiving the selection information of the data application group via the broadcast network or the communication network. Therefore, a detailed description is omitted.

In accordance with a second method, the digital media playback apparatus 200 generates the data application selection information including an selection information of the device-specific data application, and transmits the generated data application selection information to the digital media playback apparatus 200. The storage device 100 selects the device-specific data application optimized for the digital media playback apparatus 200 and transmits the selected device-specific data application to the digital media playback apparatus 200.

The digital media playback apparatus 200 may receive the selection information of the data application group via the broadcast network or the communication network. In addition, the digital media playback apparatus 200 may read the selection information of the data application group stored in the storage media. The selection information of the data application group includes the specification information of each of the one or more data application included in the data application group.

The digital media playback apparatus 200 generates the selection information of the device-specific data application by comparing the system information to the selection information of the data application group.

For instance, the digital media playback apparatus 200 may receive the selection information of the data application group for receiving and executing the data application included in the first data application group through the broadcast network while receiving and providing the digital broadcast.

When the first data application is the data application optimized for the digital media playback apparatus manufactured by the first manufacturer, the second data application is the data application optimized for the digital media playback apparatus manufactured by the second manufacturer, the third data application is the data application optimized for the communication speed of 2 Mbps, and the fourth data application is the data application optimized for the communication speed of 10 Mbps according to an analysis of the specification information included in the selection information of the data application group, and the digital media playback apparatus 200 is manufactured by the first manufacturer according to the analysis of the system information, the digital media playback apparatus 200 generates the data application selection information including the selection information of the first data application, i.e. The device-specific data application optimized for the digital media playback apparatus 200.

The data application selection information generated by the digital media playback apparatus 200 is transmitted to the storage device 100.

The storage device 100 transmits the first data application to the digital media playback apparatus 200 according to the received data application selection information.

Thereafter, the digital media playback apparatus 200 receives the data application transmitted from the storage device 100 and executes the received data application.

Through the first method and the second method, the digital media playback apparatus 200 may be provided with one of the one or more data applications optimized for the digital media playback apparatus 200 stored in the storage device 100. Therefore, a limitation in the execution of the data application due to the system specifications and manufacturer may be overcome.

FIG. 2 is a flow diagram exemplifying a method for providing a device-specific data application in accordance with the present invention.

The method in accordance with the present invention may be embodied in the digital media playback apparatus of the system in accordance with the present invention.

A detailed description thereof will be given with reference to FIG. 2.

Referring to FIG. 2, the digital media playback apparatus receives the selection information of the data application group (S100).

Thereafter, the data application selection information for selecting the device-specific data application from the one or more data applications included in the data application group stored in a storage device is generated (S110);

Thereafter, the data application selection information is transmitted to the storage device (S120).

Thereafter, the device-specific data application is received and provided from the storage device (S130).

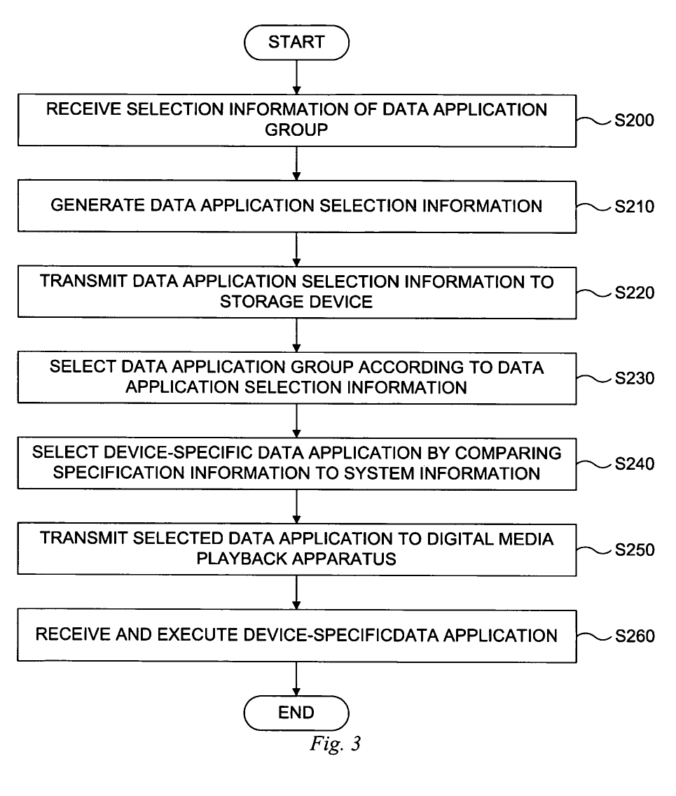

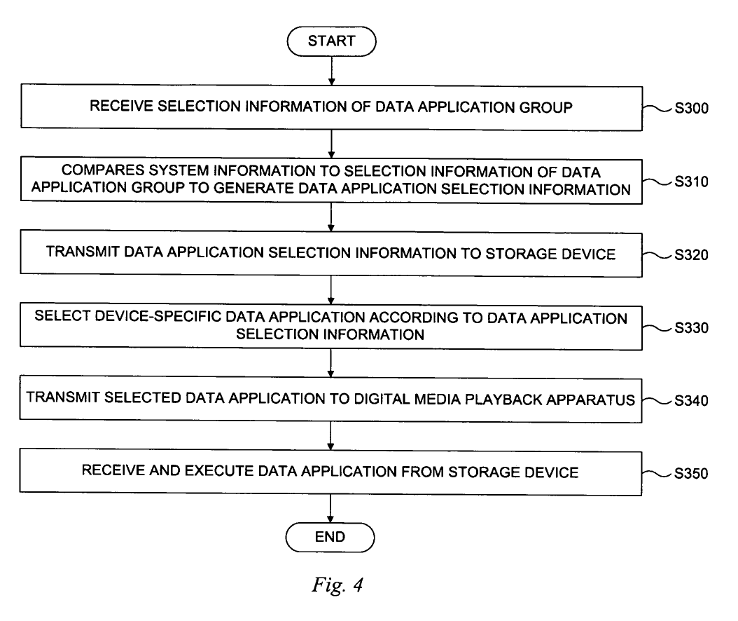

A more detailed description of the method in accordance with the present invention will be given with reference to FIGS. 3 and 4.

FIG. 3 is a flow diagram illustrating a first method for selecting the device-specific data application in accordance with the present invention.

Referring to FIG. 3, the digital media playback apparatus receives the selection information of the data application group for receiving and executing the data application included in the data application group (S200).

The digital media playback apparatus may receive the selection information of the data application group via the broadcast network or the communication network. In addition, the digital media playback apparatus may read the selection information of the data application group from the storage media.

For instance, the digital media playback apparatus may receive the selection information of the data application group for receiving and executing the data application included in the first data application group through the broadcast network while receiving and providing the digital broadcast.

Thereafter, the digital media playback apparatus generates the data application selection information including the selection information of the data application group (S210).

For instance, when the first data application group including the first data application through the fourth the data application and a second data application group including a fifth data application through a eighth the data application are stored in the storage device, the digital media playback apparatus generates the data application selection information including the selection information of the first data application group.

Thereafter, the data application selection information generated in the step S210 is transmitted to the storage device (S220).

The storage device then selects the first data application group according to the selection information of the first data application group included in the received data application selection information (S230).

The storage device selects the device-specific data application optimized for the digital media playback apparatus from the first data application through the fourth data application included in the first data application group (S240).

Specifically, the storage device compares the specification information of each of the first data application through the fourth the data application to the system information of the digital media playback apparatus included in the data application selection information to select the device-specific data application optimized for the digital media playback apparatus.

For instance, when the first data application is the data application optimized for the digital media playback apparatus manufactured by the first manufacturer, the second data application is the data application optimized for the digital media playback apparatus manufactured by the second manufacturer, the third data application is the data application optimized for the communication speed of 2 Mbps, and the fourth data application is the data application optimized for the communication speed of 10 Mbps according to an analysis of the specification information, and the digital media playback apparatus is manufactured by the first manufacturer according to the analysis of the system information, the storage device selects the first data application.

Thereafter, the storage device transmits the selected data application to the digital media playback apparatus (S250).

Thereafter, the digital media playback apparatus receives and executes the data application transmitted from the storage device (S260).

FIG. 4 is a flow diagram illustrating a second method for selecting the device-specific data application in accordance with the present invention.

Referring to FIG. 4, the digital media playback apparatus receives the selection information of the data application group for receiving and executing the data application included in the data application group (S300).

The digital media playback apparatus may receive the selection information of the data application group via the broadcast network or the communication network. In addition, the digital media playback apparatus may read the selection information of the data application group from the storage media.

Thereafter, the digital media playback apparatus compares the system information thereof to the selection information of the data application group to generate the selection information of the device-specific data application (S310).

For instance, the digital media playback apparatus may receive the selection information of the data application group for receiving and executing the data application included in the first data application group through the broadcast network while receiving and providing the digital broadcast.

When the first data application is the data application optimized for the digital media playback apparatus manufactured by the first manufacturer, the second data application is the data application optimized for the digital media playback apparatus manufactured by the second manufacturer, the third data application is the data application optimized for the communication speed of 2 Mbps, and the fourth data application is the data application optimized for the communication speed of 10 Mbps according to an analysis of the specification information included in the selection information of the data application group, and the digital media playback apparatus is manufactured by the first manufacturer according to the analysis of the system information, the digital media playback apparatus generates the selection information of the first data application, i.e. The device-specific data application.

Thereafter, the data application selection information generated in the step S3 10 is transmitted to the storage device (S320).

The storage device then selects the first data application according to the selection information of the device-specific data application included in the received data application selection information (S330).

Thereafter, the storage device transmits the selected first data application to the digital media playback apparatus (S340).

Thereafter, the digital media playback apparatus receives and executes the first data application transmitted from the storage device (S350).

Through the above-describe methods, the digital media playback apparatus may be provided with one of the one or more data applications optimized for the digital media playback apparatus stored in the storage device. Therefore, a limitation in the execution of the data application due to the system specifications and manufacturer may be overcome.

While the present invention has been particularly shown and described with reference to the preferred embodiment thereof, it will be understood by those skilled in the art that various changes in form and details may be effected therein without departing from the spirit and scope of the invention as defined by the appended claims.

What is claimed is:

1. A data application providing system, comprising:
a storage device for storing a data application group including one or more data applications; and
a digital media playback apparatus for generating a data application selection information for selecting a device-specific data application from the one or more data applications, transmitting the data application selection information to the storage device, and receiving and providing the device-specific data application from the storage device.

2. The system in accordance with claim 1, wherein the data application selection information includes a system information of the digital media playback apparatus and an selection information of the data application group, and
wherein the storage device selects the device-specific data application based on the data application selection information and transmits the device-specific data application to the digital media playback apparatus.

3. The system in accordance with claim 2, wherein the storage device selects the device-specific data application by comparing a specification information of each of the one or more data applications to the system information.

4. The system in accordance with claim 2, wherein the digital media playback apparatus receives the selection information of the data application group via a broadcast network or a communication network.

5. The system in accordance with claim 2, wherein the digital media playback apparatus reads the selection information of the data application group from a storage media.

6. The system in accordance with claim 1, wherein the data application selection information includes an selection information of the device-specific data application, and
wherein the digital media playback apparatus generates the selection information of the device-specific data application based on a system information of the digital media playback apparatus and the selection information of the data application group.

7. The system in accordance with claim 6, wherein the selection information of the data application group includes a specification information of each of the one or more data applications, and
wherein the digital media playback apparatus generates the selection information of the device-specific data application by comparing the specification information to the system information.

8. The system in accordance with claim 6, wherein the digital media playback apparatus receives the selection information of the data application group via a broadcast network or a communication network.

9. The system in accordance with claim 6, wherein the digital media playback apparatus reads the selection information of the data application group from a storage media.

10. A data application providing method, comprising steps of:
(a) generating a data application selection information for selecting a device-specific data application from one or more data applications included in a data application group stored in a storage device;
(b) transmitting the data application selection information to the storage device; and
(c) receiving and providing the device-specific data application from the storage device.

11. The method in accordance with claim 10, wherein the step (a) comprises:
(a-1) receiving the selection information of the data application group; and
(a-2) generating the data application selection information based on the selection information of the data application group.

12. The method in accordance with claim 11, wherein the step (a-1) comprises receiving the selection information of the data application group via a broadcast network or a communication network.

13. The method in accordance with claim 11, wherein the step (a-1) comprises reading the selection information of the data application group from a storage media.

14. The method in accordance with claim 11, wherein the step (a-2) comprises generating the data application selection information including a system information of the digital media playback apparatus and the selection information of the data application group.

15. The method in accordance with claim 11, wherein the data application selection information includes an selection information of the device-specific data application, and
wherein the step (a-2) comprises (a-3) generating the selection information of the device-specific data application based on a system information of the digital media playback apparatus and the selection information of the data application group.

16. The method in accordance with claim 15, wherein the selection information of the data application comprises a specification information of each of the one or more data applications, and
wherein the step (a-3) comprises generating the selection information of the device-specific data application by comparing the specification information to the system information.
